(19) United States
(12) Patent Application Publication
(10) Pub. No.: US 2022/0138687 A1
(43) Pub. Date: May 5, 2022

(54) VEHICLE INSTRUCTION DEVICE, DELIVERY MANAGEMENT SYSTEM, VEHICLE INSTRUCTION METHOD, AND STORAGE MEDIUM STORING VEHICLE INSTRUCTION PROGRAM

(71) Applicant: TOYOTA JIDOSHA KABUSHIKI KAISHA, Aichi-ken (JP)

(72) Inventors: Takahiro OKANO, Chiryu-shi (JP); Takaaki YANAGIHASHI, Toyota-shi (JP); Hiroaki KIYOKAMI, Nisshin-shi (JP); Toru TAKASHIMA, Susono-shi (JP); Kenta MIYAHARA, Okazaki-shi (JP); Yohei TANIGAWA, Toyota-shi (JP)

(21) Appl. No.: 17/517,671

(22) Filed: Nov. 3, 2021

(30) Foreign Application Priority Data
Nov. 5, 2020 (JP) 2020-185392

(51) Int. Cl. G06Q 10/08; G06Q 10/06; G01C 21/34

(52) U.S. Cl. CPC G06Q 10/08355; G01C 21/3407; G06Q 10/063116; G06Q 10/087

(57) ABSTRACT

A vehicle instruction device includes a processor. The processor is configured to acquire inventory information pertaining to an inventory of a commodity at a delivery destination, a delivery schedule pertaining to delivery of the commodity to the delivery destination by a delivery vehicle, and delivery information pertaining to a delivery status of the delivery vehicle, update the delivery schedule based on the inventory information and the delivery information, generate instruction information for entry to the delivery destination based on a priority level for receiving the commodity in the delivery schedule that has been updated, and notify the delivery vehicle of the instruction information.

### CROSS-REFERENCE TO RELATED APPLICATION

This application is based on and claims priority under 35 USC 119 from Japanese Patent Application No. 2020-185392 filed on Nov. 5, 2020, the disclosure of which is incorporated by reference herein.

### BACKGROUND

### Technical Field

This disclosure relates to a vehicle instruction device, a delivery management system, a vehicle instruction method, and a storage medium storing a vehicle instruction program, that give entry instructions to delivery vehicles.

### Related Art

Japanese Patent Application Laid-open (JP-A) No. 2018-188312 discloses a logistics center management device that can inhibit congestion at a logistics center. The logistics center management device determines an extent of congestion caused by a number of transport vehicles stopping in the logistics center and, when it has been determined that the logistics center is congested, notifies transport vehicles that are outside the logistics center and are scheduled to stop at the logistics center that the logistics center is congested.

The logistics center management device of JP-A No. 2018-188312, by temporarily regulating the entry of delivery vehicles arriving later at a delivery destination such as a factory, inhibits traffic congestion at the delivery destination.

However, in a case where there is a part whose inventory is low at the delivery destination, there is the concern that a stockout in inventory will occur as a result of the entry of the delivery vehicle carrying that good being regulated.

### SUMMARY

It is an object of this disclosure to provide a vehicle instruction device, a delivery management system, a vehicle instruction method, and a storage medium storing a vehicle instruction program, that enable delivery vehicles carrying commodity for which stocks are low to be given prioritized entry to a delivery destination.

A first aspect is a vehicle instruction device including: an acquisition unit to acquire inventory information pertaining to an inventory of a commodity at a delivery destination, a delivery schedule pertaining to delivery of the commodity to the delivery destination by a delivery vehicle, and delivery information pertaining to a delivery status of the delivery vehicle; an updating unit to update the delivery schedule based on the inventory information and the delivery information; a generation unit to generate instruction information for entry to the delivery destination based on a priority level for receiving the commodity in the delivery schedule that the updating unit has updated; and a notification unit to notify the delivery vehicles of the instruction information.

In the vehicle instruction device of the first aspect, when the acquisition unit acquires the inventory information, the delivery schedule, and the delivery information, the updating unit updates the delivery schedule based on the inventory information and the delivery information. Here, the inventory information is information pertaining to the inventories of the commodity to be used at the delivery destination. The delivery schedule, for example, includes the commodity that the delivery vehicles will deliver, the priority levels for receiving the commodity at the delivery destination, and the times when the delivery vehicles are to arrive at the delivery destination. Furthermore, the delivery information at least includes position information relating to the delivery vehicles. Additionally, when the generation unit generates the instruction information for entry to the delivery destination based on the priority levels in the delivery schedule that has been updated, the notification unit notifies the delivery vehicles of the instruction information. According to this vehicle instruction device, by considering the priority levels assigned to the commodity, delivery vehicles carrying commodity for which stocks are low can be given prioritized entry to the delivery destination.

A vehicle instruction device of a second aspect is the vehicle instruction device of the first aspect, wherein the updating unit updates the delivery schedule at least each time the acquisition unit acquires the delivery information.

According to the vehicle instruction device of the second aspect, by causing the delivery statuses of the delivery vehicles to be sequentially reflected in the delivery schedule, delivery delays can be minimized even when traffic conditions change.

A vehicle instruction device of a third aspect is the vehicle instruction device of the first or second aspect, wherein the generation unit generates instruction information to guide the delivery vehicles delivering the commodity to a parking area that is closer to an area for unloading the commodity the higher the priority levels corresponding to the commodity is.

According to the vehicle instruction device of the third aspect, the delivery vehicles are brought closer to an area for unloading the commodity the higher the priority levels of the commodity are, so commodity for which stocks are low can be delivered as soon as possible.

A vehicle instruction device of a fourth aspect is the vehicle instruction device of any one of the first to third aspects, wherein the generation unit generates instruction information including a parking area at the delivery destination when the delivery vehicle has passed through a virtual gate established on a map.

In the vehicle instruction device of the fourth aspect, the generation unit generates the instruction information at timings when the delivery vehicle has passed through the virtual gate established on the map. According to this vehicle instruction device, parking areas can be provided to drivers of the delivery vehicles at timings when the delivery vehicles arrive at the delivery destination.

A fifth aspect is a vehicle instruction method, by which a computer executes processing including: acquiring inventory information pertaining to an inventory of a commodity at a delivery destination, a delivery schedule pertaining to delivery of the commodity to the delivery destination by a delivery vehicle, and delivery information pertaining to a delivery status of the delivery vehicle; updating the delivery schedule based on the inventory information and the delivery information; generating instruction information for entry to the delivery destination based on a priority level for receiving the commodity in the delivery schedule that has been updated; and notifying the delivery vehicle of the instruction information.

In the vehicle instruction method of the fifth aspect, when the computer acquires the inventory information, the delivery schedule, and the delivery information, the computer updates the delivery schedule based on the inventory information and the delivery information. Here, the inventory information, the delivery schedule, and the delivery information are as described above. Additionally, when the computer generates the instruction information for entry to the delivery destination based on the priority levels in the delivery schedule that has been updated, the computer notifies the delivery vehicles of the instruction information. According to this vehicle instruction method, by considering the priority levels assigned to the commodity, delivery vehicles carrying commodity for which stocks are low can be given prioritized entry to the delivery destination.

A sixth aspect is a non-transitory storage medium storing a vehicle instruction program. The vehicle instruction program executable by a computer to perform processing, the processing including: acquiring inventory information pertaining to an inventory of a commodity at a delivery destination, a delivery schedule pertaining to delivery of the commodity to the delivery destination by a delivery vehicle, and delivery information pertaining to a delivery status of the delivery vehicle; updating the delivery schedule based on the inventory information and the delivery information; generating instruction information for entry to the delivery destination based on a priority level for receiving the commodity in the delivery schedule that has been updated; and notifying the delivery vehicle of the instruction information.

The vehicle instruction program stored in the non-transitory storage medium of the sixth aspect causes a computer to execute the following process. That is, when the computer acquires the inventory information, the delivery schedule, and the delivery information, the computer updates the delivery schedule based on the inventory information and the delivery information. Here, the inventory information, the delivery schedule, and the delivery information are as described above. Additionally, when the computer generates the instruction information for entry to the delivery destination based on the priority levels in the delivery schedule that has been updated, the computer notifies the delivery vehicles of the instruction information. According to this vehicle instruction program, by considering the priority levels assigned to the commodity, delivery vehicles carrying commodity for which stocks are low can be given prioritized entry to the delivery destination.

According to this disclosure, delivery vehicles carrying commodity for which stocks are low can be given prioritized entry to the delivery destination.

### BRIEF DESCRIPTION OF THE DRAWINGS

Exemplary embodiments of the present disclosure will be described in detail based on the following figures, wherein:

FIG. 1 is a drawing showing the schematic configuration of a delivery management system pertaining to a first embodiment;

FIG. 2 is a block diagram showing hardware configurations of a delivery vehicle of the first embodiment;

FIG. 3 is a block diagram showing hardware configurations of a center server of the first embodiment;

FIG. 4 is a block diagram showing functional configurations of the center server of the first embodiment;

FIG. 5 is a flowchart showing an example of the flow of a notification process executed in the center server of the first embodiment;

FIG. 6A is an example of a delivery schedule acquired in the center server of the first embodiment;

FIG. 6B is an example of instruction information generated in the center server of the first embodiment;

FIG. 7A is an example of the delivery schedule updated in the center server of the first embodiment;

FIG. 7B is an example of the instruction information generated in the center server of the first embodiment;

FIG. 8 is a block diagram showing functional configurations of the center server of a second embodiment; and

FIG. 9 is a drawing showing an example of a map in which virtual gates of the second embodiment are set, and shows their positional relationship to a delivery vehicle.

### DETAILED DESCRIPTION

A delivery management system including a vehicle instruction device of this disclosure will be described using the drawings. The delivery management system manages the delivery, by delivery vehicles such as trucks to a delivery destination such as a factory, of commodity used to manufacture products at the delivery destination.

### First Embodiment

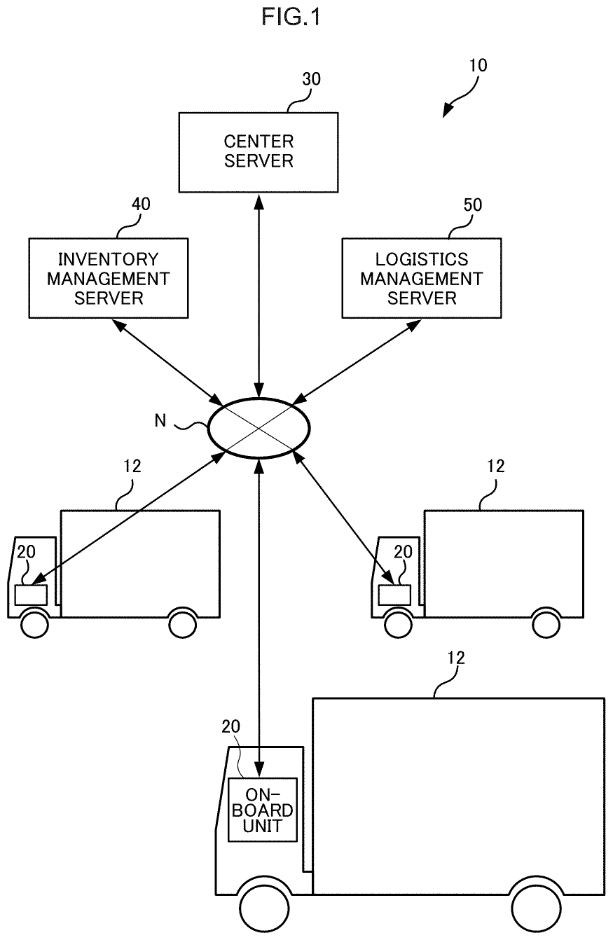

As shown in FIG. 1, a delivery management system 10 of a first embodiment is configured to include a plurality of delivery vehicles 12, a center server 30 that serves as a vehicle instruction device, an inventory management server 40, and a logistics management server 50. Each delivery vehicle 12 has an on-board unit 20 mounted in it.

The inventory management server 40 is a server installed in a factory, for example, which is a delivery destination. The inventory management server 40 manages at least manufacturing quantities of products manufactured in the factory and inventory counts of commodity used to manufacture those products. The commodity used in the manufacturing include raw materials for forming the products and assemblies assembled to the products. The inventory management server 40 of this embodiment provides inventory information relating to inventories of the commodity to the center server 30. The inventory information, for example, is information including net inventories that take into account consumption rates and so forth based on a production schedule in the factory.

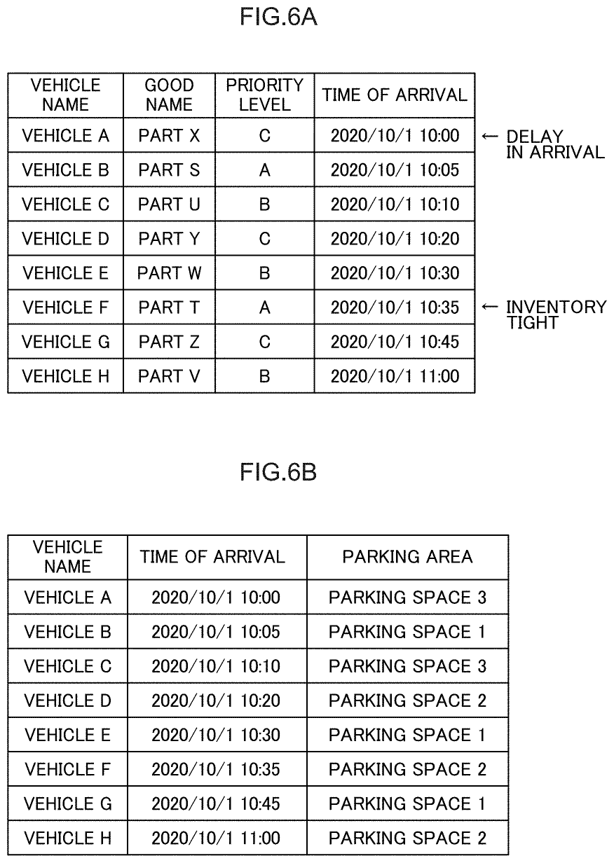

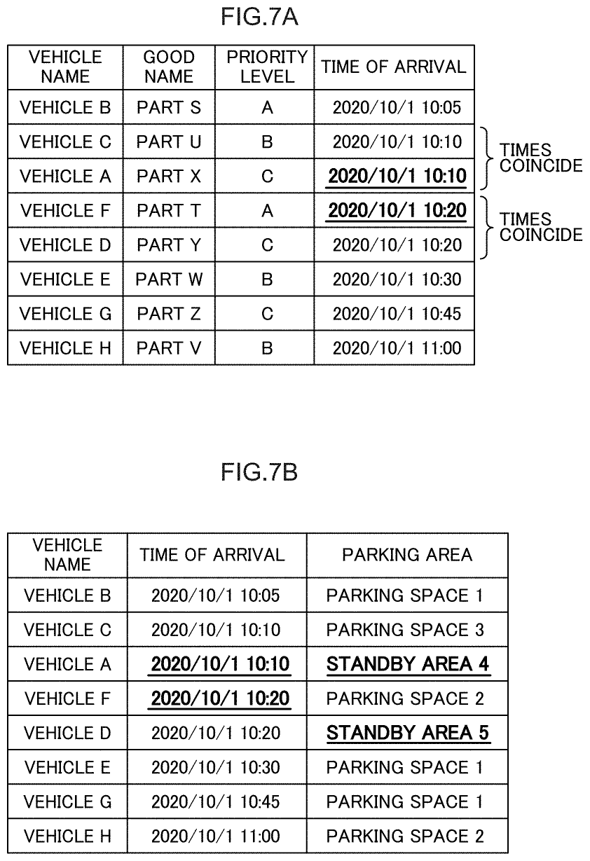

The logistics management server 50 is a server installed, for example, in the office of a business that manages the delivery vehicles 12. The logistics management server 50 designs a delivery schedule when the delivery vehicles 12 are used to deliver the commodity from delivery centers and makers of the commodity, which are shipment origins, to the delivery destination. The delivery schedule is designed taking into account the total quantity of commodity to be loaded in the delivery vehicles 12, the quantities of commodity to be delivered to one or plural delivery destinations, and the delivery routes of the delivery vehicles 12. The delivery schedule prescribes at least the delivery vehicles 12 to be used, the commodity to be delivered, priority levels corresponding to the commodity, and times of arrival at the delivery destination (see FIG. 6A and FIG. 7A). It will be noted that the priority levels will be described later. The logistics management server 50 of this embodiment provides the delivery schedule that has been designed to the center server 30.

The plurality of the on-board units 20, the center server 30, the inventory management server 40, and the logistics management server 50 are connected to each other through a network N. It will be noted that although in FIG. 1 three on-board units 20, one inventory management server 40, and one logistics management server 50 are connected to one center server 30, the numbers the of on-board units 20, inventory management servers 40, and logistics management server 50 that are connected are not limited to these.

(Vehicle)

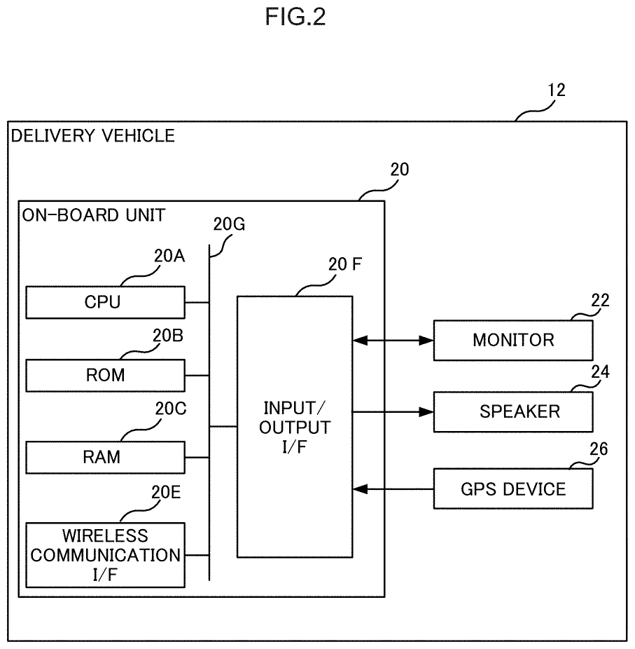

As shown in FIG. 2, the delivery vehicles 12 pertaining to this embodiment are each configured to include the on-board unit 20, a monitor 22, a speaker 24, and a GPS device 26.

The on-board unit 20 is configured to include a central processing unit (CPU) 20A, a read-only memory (ROM) 20B, a random-access memory (RAM) 20C, a wireless communication interface (I/F) 20E, and an input/output I/F 20F. The CPU 20A, the ROM 20B, the RAM 20C, the wireless communication I/F 20E, and the input/output I/F 20F are communicably connected to each other via an internal bus 20G.

The CPU 20A is a central processing unit, executes various types of programs, and controls each part of the on-board unit 20. That is, the CPU 20A reads programs from the ROM 20B and executes the programs using the RAM 20C as a workspace.

The ROM 20B stores various types of programs and various types of data. The ROM 20B of this embodiment stores a control program for controlling the on-board unit 20.

The RAM 20C temporarily stores programs or data as a workspace.

The wireless communication I/F 20E is a wireless communication module for communicating with the center server 30. The wireless communication module uses a communication standard such as 5G, LTE, or Wi-Fi (registered trademark), for example. The wireless communication I/F 20E is connected to the network N.

The input/output I/F 20F is an interface for communicating with the monitor 22, the speaker 24, and the GPS device 26 that are mounted in the delivery vehicle 12.

The monitor 22 is provided in an instrument panel or a dashboard, for example, and is a liquid crystal monitor for displaying instruction information described later. Furthermore, the monitor 22 of this embodiment has a touch panel to, for example, allow the driver of the delivery vehicle 12 to input information by operating the touch panel.

The speaker 24 is provided in the instrument panel, a center console, a front pillar, or the dashboard, for example, and is a device for outputting speech. It will be noted that the speaker 24 may also be provided in the monitor 22. The speaker 24 outputs a voice reading aloud the instruction information.

The GPS device 26 is a device that locates the current position of the delivery vehicle 12. The GPS device 26 includes an antenna that receives signals from GPS satellites. It will be noted that the GPS device 26 may also be connected to the on-board unit 20 via a car navigation system.

The on-board unit 20 of this embodiment provides to the center server 30 position information relating to the delivery vehicle 12 acquired by the GPS device 26 and delivery information including the commodity that have been loaded in the delivery vehicle 12 and the quantities thereof. It will be noted that the quantities of the commodity loaded on the delivery vehicle 12 may be changed by the driver performing predetermined operations on the touch panel of the monitor 22 or may be acquired from a mobile device for delivery that the driver has.

Furthermore, the on-board unit 20 of this embodiment receives from the center server 30 the instruction information for guiding the delivery vehicle 12 and allowing it entry to the delivery destination. The instruction information at least includes, for each delivery vehicle 12, information such as a time of arrival when the delivery vehicle 12 is to arrive at the delivery destination and a parking area.

(Center Server)

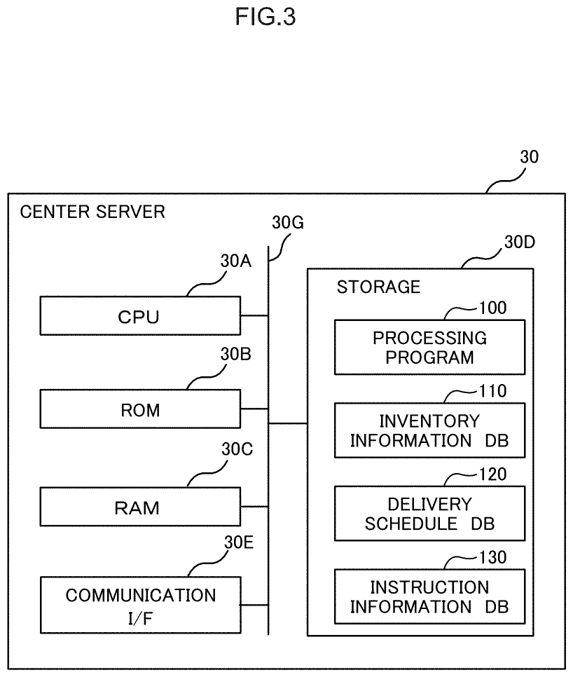

As shown in FIG. 3, the center server 30 is configured to include a CPU 30A, a ROM 30B, a RAM 30C, a storage 30D, and a communication I/F 30E. The CPU 30A, the ROM 30B, the RAM 30C, the storage 30D, and the communication I/F 30E are communicably connected to each other via an internal bus 30G. The functions of the CPU 30A, the ROM 30B, the RAM 30C, and the communication I/F 30E are the same as those of the CPU 20A, the ROM 20B, the RAM 20C, and the wireless communication I/F 20E of the on-board unit 20 described above.

The storage 30D, which serves as a storage unit, is configured by a hard disk drive (HDD) or a solid-state drive (SSD) and stores various types of programs and various types of data.

The CPU 30A reads the programs from the storage 30D and executes the programs using the RAM 30C as a workspace.

The storage 30D of this embodiment stores a processing program 100, an inventory information database (DB) 110, a delivery schedule DB 120, and an instruction information DB 130.

The processing program 100, which serves as a vehicle instruction program, is a program for realizing functions that the center server 30 has.

The inventory information DB 110 is a database in which is consolidated one or plural sets of inventory information provided and acquired from the inventory management server 40. For example, the inventory information DB 110 stores inventory counts per good per factory.

The delivery schedule DB 120 is a database in which is consolidated one or plural delivery schedules provided and acquired from the logistics management server 50. For example, the delivery schedule DB 120 stores delivery schedules per delivery vehicle 12.

The instruction information DB 130 is a database in which is consolidated the instruction information per delivery vehicle 12 generated in a generation unit 220 described later.

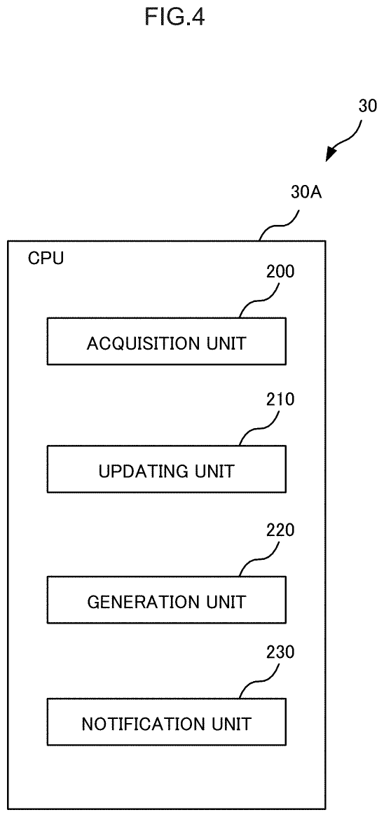

As shown in FIG. 4, in the center server 30 of this embodiment, the CPU 30A functions as an acquisition unit 200, an updating unit 210, a generation unit 220, and a notification unit 230 by executing the processing program 100.

The acquisition unit 200 has the function of acquiring the inventory information, the delivery schedule, and the delivery information. The acquisition unit 200 acquires the inventory information by communication from the inventory management server 40, acquires the delivery schedule by communication from the logistics management server 50, and acquires the delivery information by communication from the on-board units 20.

The updating unit 210 has the function of updating the delivery schedule. Specifically, the updating unit 210 updates the delivery schedule on the basis of the inventory information and the delivery information that the acquisition unit 200 has acquired. For example, in a case where the inventory count of a good has fallen below a predetermined count, the updating unit 210 updates the delivery schedule to speed up the delivery of that good, that is, so that the time when the delivery vehicle 12 will arrive at the delivery destination is sooner. Furthermore, for example, in a case where the time when a delivery vehicle 12 will arrive at the delivery destination is significantly delayed due to traffic congestion, the updating unit 210 updates the time when the delivery vehicle 12 will arrive at the delivery destination and updates the delivery schedule so that the time when another delivery vehicle 12 carrying the same good will arrive at the delivery destination is sooner. The updating unit 210 updates the delivery schedule at least each time the acquisition unit 200 acquires the delivery information. In other words, the updating unit 210 causes the position information relating to the delivery vehicles 12 and the quantities of commodity that the delivery vehicles 12 are carrying to be sequentially reflected in the delivery schedule.

The generation unit 220 has the function of generating the instruction information for the delivery vehicles 12. Specifically, the generation unit 220 references the delivery schedule that the updating unit 210 has updated and generates the instruction information on the basis of priority levels for receiving the commodity. Here, the priority levels are levels that have been preset on the basis of the importance, substitutability, or expiration date of the commodity used to manufacture the products, or a combination of these. For example, in a case where the priority levels are based on importance, the priority levels become higher the more important the commodity are to the products. Furthermore, for example, in a case where the priority levels are based on substitutability, the priority levels become lower the more substitutable and all-purpose the commodity are. Furthermore, for example, in a case where the priority levels are based on expiration date, the priority levels become higher the shorter the expiration date is.

Furthermore, the generation unit 220 of this embodiment generates instruction information to guide the delivery vehicles 12 delivering the commodity to parking areas that are closer to areas for unloading the commodity the higher the priority levels corresponding to the commodity are.

The notification unit 230 has the function of notifying the delivery vehicles 12 of the instruction information that the generation unit 220 has generated.

(Control Flow)

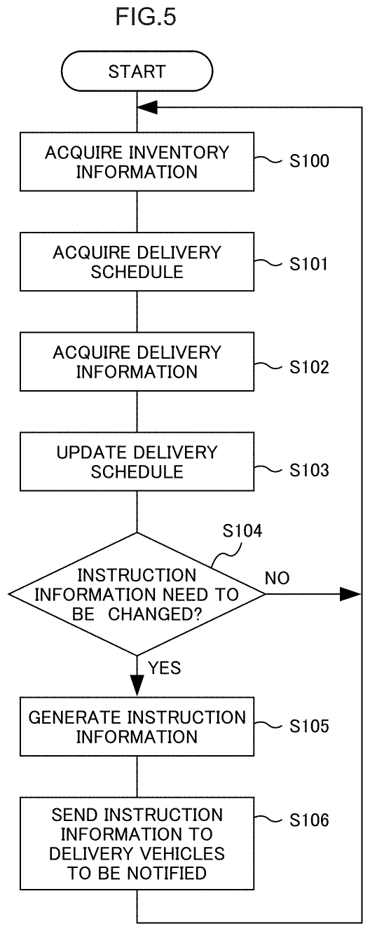

The flow of a notification process executed in the center server 30 of this embodiment, which is a vehicle instruction method of this disclosure, will now be described using the flowchart of FIG. 5. This process is realized by the CPU 30A functioning as the acquisition unit 200, the updating unit 210, the generation unit 220, and the notification unit 230.

In step S100 of FIG. 5 the CPU 30A of the center server 30 acquires the inventory information. That is, the CPU 30A acquires the inventory information from the inventory management server 40 or already stored in the inventory information DB 110.

In step S101 the CPU 30A acquires the delivery schedule. That is, the CPU 30A acquires the delivery schedule from the logistics management server 50 or already stored in the delivery schedule DB 120.

In step S102 the CPU 30A acquires the delivery information. That is, the CPU 30A acquires the delivery information from the on-board units 20.

In step S103 the CPU 30A updates the delivery schedule. Specifically, the CPU 30A updates the delivery schedule on the basis of the inventory information and the delivery information it has acquired.

In step S104 the CPU 30A determines whether or not it needs to change the instruction information. Specifically, the CPU 30A determines whether or not it needs to change at least one of the times of arrival and the parking areas in the instruction information. The CPU 30A proceeds to step S105 in a case where it has determined that it needs to change the instruction information (in the case of YES in step S104). The CPU 30A returns to step S100 in a case where it has determined that it does not need to change the instruction information (in the case of NO in step S104). It will be noted that in a case where the instruction information has thus far not been generated, the CPU 30A determines that it needs to change the instruction information and proceeds to step S105.

In step S105 the CPU 30A generates the instruction information. That is, instruction information including new times of arrival and/or new parking areas is generated in accordance with the changes in the times of arrival and the parking areas.

In step S106 the CPU 30A sends the instruction information to the delivery vehicles 12 that are to be notified. Then, the CPU 30A returns to step S100.

In the notification process of this embodiment, the delivery schedule is updated at least each time the CPU 30A acquires the delivery information, and in a case where there is a change in at least one of the times of arrival and the parking areas, the instruction information is sent to the delivery vehicles 12 (specifically, the on-board units 20) that are to be notified. Meanwhile, in the delivery vehicles 12 that have received the instruction information, the drivers are notified of the content of the instruction information through the monitor 22 and the speaker 24.

(Example Where Delivery Information is Updated)

An example where the delivery information is updated as a result of the notification process executed in the center server 30 of this embodiment will now be described using FIG. 6A, FIG. 6B, FIG. 7A, and FIG. 7B.

FIG. 6A shows an example of a delivery schedule first acquired from the logistics management server 50. In the delivery schedule in FIG. 6A, information including vehicle names of the delivery vehicles 12, names of commodity to be delivered, priority levels, and times of arrival are stored in the order of the times of arrival. It will be noted that the delivery vehicles 12 include eight vehicles, vehicle A to vehicle H, that drive to the delivery destination, and the commodity include eight types of parts, part S to part Z, that are to be delivered to the delivery destination.

Furthermore, the priority levels are set in three levels ranging from A to C, with the priority level becoming lower going from A to C. Part S and part T are set to priority level A, part U, part V, and part W are set to priority level B, and part X, part Y, and part Z are set to priority level C.

On the basis of the delivery schedule shown in FIG. 6A, the instruction information shown in FIG. 6B is generated. In the instruction information in FIG. 6B, information including the vehicle names of the delivery vehicles 12, the times of arrival, and the parking areas is stored in the order of the times of arrival. It will be noted that the times of arrival in the delivery schedule are applied as is to the times of arrival in the instruction information.

Furthermore, the parking areas correspond to destinations of the delivery vehicles 12 on the site of the delivery destination. As the parking areas in this embodiment, five areas including a parking space 1 to a parking space 3 as well as a standby area 4 and a standby area 5 are prepared. Parking space 1 is the nearest area for unloading part S, part W, and part Z; parking space 2 is the nearest area for unloading part T, part V, and part Y; and parking space 3 is the nearest area for unloading part U and part X. It will be assumed that only one delivery vehicle 12 can park in each parking area. Standby area 4 and standby area 5 are spaces reserved for parking but which are also not areas for unloading any of the parts.

FIG. 7A is an example of a delivery schedule that has been updated on the basis of newly acquired inventory information and delivery information. The delivery schedule in FIG. 7A is an example in a case where the inventory of part T is tight as a result of it becoming lower than expected at the factory that is the delivery destination and where the arrival of vehicle A is delayed beyond the time of arrival (see FIG. 6A).

First, it will be assumed that the times of arrival of vehicle A and vehicle C now coincide as a result of the time of arrival of vehicle A being delayed from the initial 10:00 to 10:10. The parking areas for vehicle A and vehicle C in the initial instruction information are both parking space 3, so in addition to the times of arrival coinciding, the parking areas also now coincide as a result of the arrival of vehicle A being delayed. In this case, because the priority level of part X that vehicle A will deliver is lower than the priority level of part U that vehicle C will deliver, new instruction information is generated to prioritize the unloading of part U (see FIG. 7B). That is, the CPU 30A leaves the parking area for vehicle C as is but changes the parking area for vehicle A from parking space 3 to standby area 4. As a result, although the time when part X will be unloaded from vehicle A becomes later, there is less of an effect on manufacturing than there would be if the unloading of part U were to be delayed, because the priority level of part X is lower than the priority level of part U.

Next, it will be assumed that the time of arrival of vehicle F is bumped up from the initial 10:35 to 10:20 in the delivery schedule because the inventory of part T is tight, and, as a result, the time of arrival of vehicle F now coincides with the time of arrival of vehicle D. The parking areas for vehicle D and vehicle F in the initial instruction information are both parking space 2, so in addition to the times of arrival coinciding, the parking areas also now coincide as a result of bumping up the arrival of vehicle F. In this case, because the priority level of part T that vehicle F will deliver is higher than the priority level of part Y that vehicle D will deliver, new instruction information is generated to prioritize the unloading of part T (see FIG. 7B). That is, the CPU 30A leaves the parking area for vehicle F as is but changes the parking area for vehicle D from parking space 2 to standby area 5. As a result, although the time when part Y will be unloaded from vehicle D becomes later, the unloading of part T, whose inventory is tight, can be speedily performed.

### Summary of Embodiment

In the center server 30 of this embodiment, when the acquisition unit 200 acquires the inventory information, the delivery schedule, and the delivery information, the updating unit 210 updates the delivery schedule on the basis of the inventory information and the delivery information. Additionally, when the generation unit 220 generates the instruction information for entry to the delivery destination on the basis of the priority levels in the delivery schedule that has been updated, the notification unit 230 notifies the delivery vehicles 12 of the instruction information.

In this connection, even when the times when the delivery vehicles 12 that have departed from each supplier are to arrive at the delivery destination are scheduled in advance in accordance with the delivery schedule, in reality the times of arrival change due to traffic conditions and so forth. Additionally, if a delivery vehicle 12 that is to be received when it has actually arrived at the delivery destination is stuck in traffic, the drivers of the delivery vehicles 12 from different suppliers do not know the priority ranking in which the vehicles are to be received. For that reason, the judgments of the drivers cannot be relied upon to give prioritized entry to delivery vehicles 12 carrying commodity for which stocks are low. In contrast, according to this embodiment, delivery vehicles 12 carrying commodity for which stocks are low can be given prioritized entry to the delivery destination in consideration of the priority levels.

In particular, according to this embodiment, the delivery vehicles 12 are brought closer to areas for unloading the commodity the higher the priority levels of the commodity are, so commodity for which stocks are low can be unloaded as quickly as possible.

Furthermore, according to this embodiment, by causing the delivery statuses of the delivery vehicles 12 to be sequentially reflected in the delivery schedule, delivery delays can be minimized even when traffic conditions change.

### Second Embodiment

In the center server 30 of the first embodiment, the instruction information is generated when at least one of the times of arrival and the parking areas needs to be changed, but in this second embodiment, the instruction information is generated when the delivery vehicles 12 have passed through virtual gates G provided in front of the delivery destination. Below, differences from the first embodiment will be described. It will be noted that the same reference signs are assigned to the same description, and that description will be omitted.

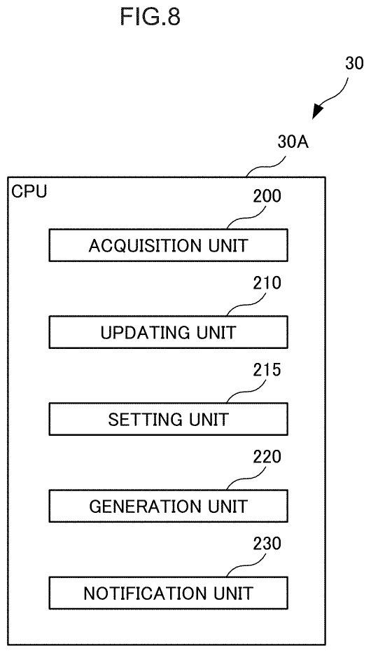

As shown in FIG. 8, in the center server 30 of this embodiment, the CPU 30A functions as the acquisition unit 200, the updating unit 210, a setting unit 215, the generation unit 220, and the notification unit 230 by executing the processing program 100.

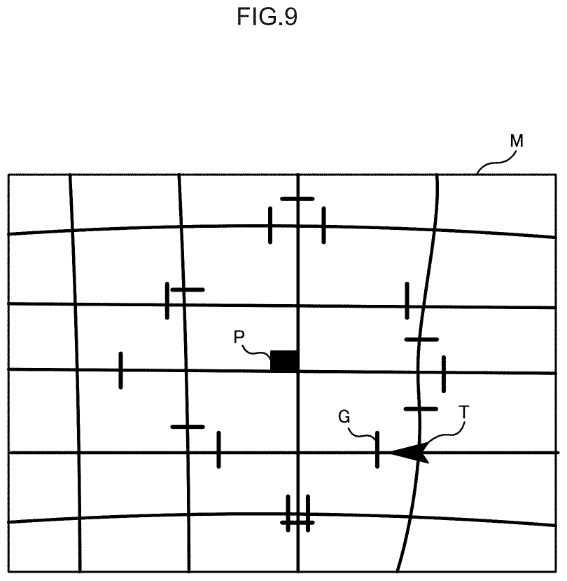

As shown in FIG. 9, the setting unit 215 has the function of setting virtual gates G on a map M. The virtual gates G are set in points a predetermined amount of time before arrival (e.g., points 5 minutes before arrival) at a destination P representing the delivery destination or points a predetermined distance from the destination P (e.g., points a distance of 3 km away on routes).

The generation unit 220 of this embodiment generates the instruction information when the delivery vehicle 12 has passed through the virtual gate G. Specifically, the generation unit 220 generates the instruction information when target T representing the delivery vehicle 12 on the map M has arrived at the virtual gates G. The instruction information at least includes parking areas at the delivery destination.

In this embodiment, which is configured as described above, the generation unit 220 generates the instruction information at timings when the delivery vehicle 12 has passed through the virtual gate G set on the map M. For that reason, according to this embodiment, parking areas can be provided to the drivers of the delivery vehicles 12 at timings when the delivery vehicles 12 arrive at the delivery destination.

It will be noted that the positions of the virtual gates G do not need to be fixed and may be changed depending on traffic conditions, delivery times, and/or meteorological information. Alternatively, the positions of the virtual gates G may be fixed, and in this case, by storing the position information relating to the virtual gates beforehand in map data, the setting unit 215 becomes unnecessary.

Remarks

It will be noted that various types of processors other than CPUs may also execute the various types of processes that the CPUs 20A, 30A executed by reading software (programs) in the above embodiments. Examples of the processors in this case include programmable logic devices (PLDs) whose circuit configuration can be changed after manufacture, such as field-programmable gate arrays (FPGAs), and dedicated electrical circuits that are processors having a circuit configuration dedicatedly designed for executing specific processes, such as application-specific integrated circuits (ASICs). Furthermore, the processes described above may be executed by one of these various types of processors or may be executed by a combination of two or more processors of the same type or different types (e.g., plural FPGAs, and a combination of a CPU and an FPGA, etc.). Furthermore, the hardware structures of these various types of processors are more specifically electrical circuits in which circuit elements such as semiconductor elements are combined.

Moreover, in the above embodiments, each program was described as being stored (installed) beforehand in a computer-readable non-transitory storage medium. For example, the control program in the on-board unit 20 is stored beforehand in the ROM 20B, and the processing program 100 in the center server 30 is stored beforehand in the storage 30D. However, the programs are not limited to this and may also be provided in a form in which they are recorded in non-transitory recording media such as a compact disc read-only memory (CD-ROM), a digital versatile disc read-only memory (DVD-ROM), and a universal serial bus (USB) memory. Furthermore, the programs may also take a form in which they are downloaded via a network from an external device.

The processes in the above embodiments may also be executed not just by one processor but also by plural processors working together. The process flow described in the above embodiments is also an example, and unnecessary steps may be omitted, new steps may be added, and process orders may also be changed in a range that does not depart from the spirit of the disclosure.

What is claimed is:

1. A vehicle instruction device, comprising a processor, the processor being configured to:
acquire inventory information pertaining to an inventory of a commodity at a delivery destination, a delivery schedule pertaining to delivery of the commodity to the delivery destination by a delivery vehicle, and delivery information pertaining to a delivery status of the delivery vehicle;
update the delivery schedule based on the inventory information and the delivery information;
generate instruction information for entry to the delivery destination based on a priority level for receiving the commodity in the delivery schedule that has been updated; and
notify the delivery vehicle of the instruction information.

2. The vehicle instruction device of claim 1, wherein the processor updates the delivery schedule at least each time it acquires the delivery information.

3. The vehicle instruction device of claim 1, wherein the processor generates instruction information to guide the delivery vehicle delivering the commodity to a parking area that is closer to an area for unloading the commodity the higher the priority level corresponding to the commodity is.

4. The vehicle instruction device of claim 1, wherein the processor generates instruction information including a parking area at the delivery destination when the delivery vehicle has passed through a virtual gate established on a map.

5. The vehicle instruction device of claim 4, wherein the processor changes the position of the virtual gate based on information relating to at least one of traffic conditions, a delivery time, or meteorological information.

6. A delivery management system, comprising:
the vehicle instruction device of claim 1;
an inventory management server that provides the inventory information to the vehicle instruction device;
a logistics management server that provides the delivery schedule to the vehicle instruction device; and
an on-board unit that is mounted in each of a plurality of the delivery vehicles and that is configured to provide the delivery information to the vehicle instruction device.

7. A vehicle instruction method, by which a computer executes processing comprising:
acquiring inventory information pertaining to an inventory of a commodity at a delivery destination, a delivery schedule pertaining to delivery of the commodity to the delivery destination by a delivery vehicle, and delivery information pertaining to a delivery status of the delivery vehicle;
updating the delivery schedule based on the inventory information and the delivery information;
generating instruction information for entry to the delivery destination based on a priority level for receiving the commodity in the delivery schedule that has been updated; and
notifying the delivery vehicle of the instruction information.

8. A non-transitory storage medium storing a vehicle instruction program executable by a computer to perform processing, the processing comprising:
acquiring inventory information pertaining to an inventory of a commodity at a delivery destination, a delivery schedule pertaining to delivery of the commodity to the delivery destination by a delivery vehicle, and delivery information pertaining to a delivery status of the delivery vehicle;
updating the delivery schedule based on the inventory information and the delivery information;
generating instruction information for entry to the delivery destination based on a priority level for receiving the commodity in the delivery schedule that has been updated; and
notifying the delivery vehicle of the instruction information.
